(19) United States
(12) Patent Application Publication
(10) Pub. No.: US 2025/0138480 A1
(43) Pub. Date: May 1, 2025

(54) BALANCE SPRING FOR A WATCH RESONATER MECHANISM EQUIPPED WITH SYMMETRICAL STIFFNESS ADJUSTMENT MEANS

(71) Applicant: The Swatch Group Research and Development Ltd, Marin (CH)

(72) Inventors: Mohammad Hussein KAHROBAIYAN, Boudevilliers (CH); Romain Le Moal, Villers-le-Lac (FR); Julien Christan, Bienne (CH); Ivan Hernandez, Cressier (CH)

(73) Assignee: The Swatch Group Research and Development Ltd, Marin (CH)

(21) Appl. No.: 18/903,564

(22) Filed: Oct. 1, 2024

(30) Foreign Application Priority Data
Oct. 25, 2023 (EP) 23205856.0

(51) Int. Cl. G04B 18/04; G04B 17/06

(52) U.S. Cl. CPC G04B 18/04; G04B 17/06

(57) ABSTRACT

A balance spring for a watch resonator mechanism, the balance spring (100) including a flexible strip (2) wound on itself in a plurality of coils, the strip (2) having a predefined stiffness, the balance spring (100) including means for adjusting its stiffness, including a flexible element (5) arranged in series with the strip (2), the flexible element (5) connecting one end (4) of the strip (2) to a fixed mount (38), so as to add additional stiffness to the continuation of the strip (2), the flexible element (5) preferably having a stiffness greater than that of the strip (2), the flexible element (5) including two flexible parts (15, 16) each connecting the strip (2) to the fixed mount (38), the two flexible parts (15, 16) being arranged relative to each other with axial symmetry along an axis (A) preferably passing substantially through the centre (0) of the balance spring.

### CROSS REFERENCE TO RELATED APPLICATIONS

This application claims priority to European Patent Application No. 23205856.0 filed Oct. 25, 2023, the entire contents of which are incorporated herein by reference.

### TECHNICAL FIELD OF THE INVENTION

The invention relates to a balance spring for a watch resonator mechanism, the balance spring being equipped with symmetrical means for adjusting the stiffness of said balance spring. The invention also relates to a watch resonator mechanism equipped with such a balance spring.

### TECHNOLOGICAL BACKGROUND

In the majority of mechanical watches, the energy required to rotate the hands (e.g. the minute and hour hands) is stored in a barrel and then delivered by a sprung balance system, which comprises a flywheel known as a sprung balance, combined with a spring in the form of a spiral wound strip, known as a balance spring.

An inner end of the balance spring is attached to an integral shaft that rotates with the sprung balance; an outer end of the balance spring is attached to a balance spring stud mounted on a stud holder that is itself integral to a fixed bridge (or cock).

The rotation of the sprung balance is maintained—and its oscillations counted—by an escapement mechanism comprising a pallet driven by a low-amplitude oscillating movement, equipped with two pallets which engage in the teeth of an escape wheel. When the escape wheel is engaged in this way, a step-by-step rotational movement is imposed on it, the frequency of which is determined by the frequency of oscillation of the pallet, which is itself aligned to the frequency of oscillation of the sprung balance).

In a traditional escapement mechanism, the oscillation frequency is approximately 4 Hz, or approximately 28,800 vibrations per hour (A/h). One of the aims of good watchmakers is to ensure the isochronism and regularity of oscillation (or constant rate) of the sprung balance.

The practice of regulating the rate of the sprung balance by adjusting the active length of the balance spring, defined as the curvilinear length between its inner end and a counting-point, located in the vicinity of the outer end of the balance spring and generally defined by a pair of stops supported by a pin mounted on an index assembly system, is known.

In operation, this index assembly system is rotationally fixed relative to the axis of the balance spring. However, its angular position can be manually fine-tuned, e.g. by rotating an eccentric acting like a cam on the index assembly system using a screwdriver.

The assembly comprising the bridge, the index assembly system, the pin, the stud holder, the balance spring stud, the shaft, the spring and the sprung balance is commonly known as the “regulator”. Examples of regulators appear in international application WO 2016/192957 and European patent EP 2 876 504, both in the name of the watch manufacturer ETA.

There are index assembly systems with a stud holder to which one end of the balance spring is attached, and where the index assembly system pin leaves sufficient play to allow the balance spring to move between the two stops. However, the chronometric properties, in particular anisochronism as a function of amplitude, are very sensitive to play at the index pin, where this play is difficult to control precisely.

In certain devices, the stops can be adjusted to tighten the balance spring in order to eliminate play, particularly during operation of the balance spring. In this case, the rate is first adjusted by moving the index pin, then by tightening the balance spring with the pin. However, tightening the balance spring with the index pin risks stressing it and creating chronometric faults, in particular by decentring the coils. In addition, eliminating the play also alters the rate, and once the balance spring has been tightened, the index pin can no longer be moved along the balance spring to finish fine-tuning the rate.

Other balance springs have an integrated adjustment device. In these balance springs, the rate is not adjusted by altering the effective length of the balance spring, but by applying a force or torque to a flexible element arranged in series with the balance spring. In effect, a flexible element is placed in series with the strip between one end of the strip and a fixed mount to alter the stiffness of the pinning point and provide the resonator with additional flexibility. In this way, the effective stiffness of the resonator includes the stiffness of the strip and the stiffness of the flexible element.

A variable force or torque is then applied to pre-stress the flexible element. By pre-stressing the flexible element, its stiffness, from which the return force acting on the sprung balance partly results, changes, while the stiffness of the strip remains unchanged. By altering this stiffness of the flexible element, the stiffness of the entire resonator (stiffness of the strip and stiffness of the flexible element) changes, which consequently alters the rate of the resonator and enables the frequency of the time base to be precisely adjusted. This provides a high degree of precision in adjusting the rate, as only one element is used to adjust the stiffness.

Such a balance spring fitted with an elastic element is described, for example, in patent application EP4009115 filed on behalf of Omega SA.

However, the geometric configuration of the flexible element creates the risk of creep affecting the adhesive used to attach the fixed mount for the balance spring in the movement. In effect, the position of the fixed mount and the orientation of the force or torque applied to the flexible element generates stresses on the adhesive, which can lead to it creeping, and therefore an alteration the precision of adjustment.

In addition, the direction in which the adjustment force is applied may differ from the intended direction due to manufacturing, assembly or alignment errors, etc. This difference will have the effect of altering the rate and degrading the precision of adjustment.

In addition, because of impacts and friction, there may be hysteresis in the adjustment mechanism, as the direction in which the force is applied changes and does not return to the initial direction after the impact.

The result is an alteration in the rate and a deterioration in the precision of adjustment.

### SUMMARY OF THE INVENTION

The aim of the present invention is to overcome some or all of the aforementioned disadvantages, in particular to minimise sensitivity to changes in the direction of the adjustment force, by providing a balance spring equipped with effective and precise adjustment means, configured in particular to adjust the rate of a timepiece by altering the effective stiffness of said balance spring.

To this end, the invention relates to a balance spring for a watch resonator mechanism, the balance spring comprising a flexible strip wound on itself in a plurality of coils, the strip having a predefined stiffness, the balance spring including means for adjusting its stiffness, the adjustment means including a flexible element arranged in series with the strip, the flexible element connecting one end of said strip to a fixed mount, so as to add additional stiffness to the continuation of the strip, the flexible element preferably having a stiffness greater than that of the strip.

The invention is remarkable in that the flexible element includes two flexible parts, each connecting the strip to the fixed mount, the two parts being arranged relative to each other with axial symmetry along an axis, the axis (A) preferably passing substantially through the centre of the balance spring.

Thanks to the symmetrical arrangement of the flexible element in two parts, a balanced variable force or torque can be applied, avoiding the risk of creep affecting the adhesive used to attach the fixed mount in the movement. In effect, the force or torque is more evenly distributed over the flexible element, and therefore over the joint between the fixed mount and the movement.

According to a particular embodiment of the invention, the flexible element is arranged at an outer end of the strip.

According to a particular embodiment of the invention, the two flexible parts are substantially identical.

According to a particular embodiment of the invention, each flexible part comprises one or two flexible necks.

According to a particular embodiment of the invention, each flexible part includes a translation table equipped with two substantially parallel flexible blades and a movable rigid part to which the strip is connected.

According to a particular embodiment of the invention, the flexible element comprises a flexible guide equipped with two offset blades.

According to a particular embodiment of the invention, the flexible part comprises a flexible blade.

According to a particular embodiment of the invention, each flexible part comprises a flexible arm to which the strip is connected.

According to a particular embodiment of the invention, each flexible part comprises a flexible hook.

According to a particular embodiment of the invention, the adjustment means include pre-stressing means for applying a variable force or torque to the flexible element, so as to vary the stiffness of the flexible element only.

According to a particular embodiment of the invention, the pre-stressing means are configured to apply a variable force or torque to each part of the flexible element.

According to a particular embodiment of the invention, the torque or force is continuously adjustable by the pre-stressing means.

According to a particular embodiment of the invention, the pre-stressing means are configured to apply an identical variable force or torque to each part of the flexible element.

According to a particular embodiment of the invention, the pre-stressing means comprise a screw configured to rest against the flexible element.

According to a particular embodiment of the invention, the pre-stressing means comprise two flexible levers each connected to a flexible part.

According to a particular embodiment of the invention, the pre-stressing means comprise two springs, each spring being connected to a flexible part.

According to a particular embodiment of the invention, the pre-stressing means comprise a secondary flexible blade connected to each flexible part.

According to a particular embodiment of the invention, the two levers are connected to each other by a movable body.

The invention also relates to a rotary resonator mechanism, in particular for a watch movement, including an oscillating weight and such a balance spring.

### BRIEF DESCRIPTION OF THE DRAWINGS

The aims, advantages and characteristics of the present invention will become apparent from a number of embodiments provided solely by way of non-exhaustive examples, with reference to the appended drawings in which:

FIG. 1 schematically represents a top view of a balance spring according to a first embodiment of the invention,

FIG. 2 schematically represents a top view of a balance spring according to a second embodiment of the invention,

FIG. 3 schematically represents a top view of a balance spring according to a third embodiment of the invention,

FIG. 4 schematically represents a top view of a balance spring according to a fourth embodiment of the invention,

FIG. 5 shows schematically a top view of a balance spring according to a fifth embodiment of the invention,

FIG. 6 schematically represents a top view of a balance spring according to a sixth embodiment of the invention,

FIG. 7 schematically represents a top view of a balance spring according to a seventh embodiment of the invention,

FIG. 8 shows schematically a top view of a balance spring according to an eighth embodiment of the invention,

FIG. 9 schematically represents a top view of a balance spring according to a ninth embodiment of the invention,

FIG. 10 schematically represents a top view of a balance spring according to a tenth embodiment of the invention,

FIG. 11 schematically represents a top view of a balance spring according to an eleventh embodiment of the invention,

FIG. 12 shows schematically a top view of a balance spring according to a twelfth embodiment of the invention, and

FIG. 13 shows schematically a top view of a balance spring according to a thirteenth embodiment of the invention, and

FIG. 14 is an enlarged view of part of the balance spring according to the thirteenth embodiment of the invention in FIG. 13.

### DETAILED DESCRIPTION OF THE INVENTION

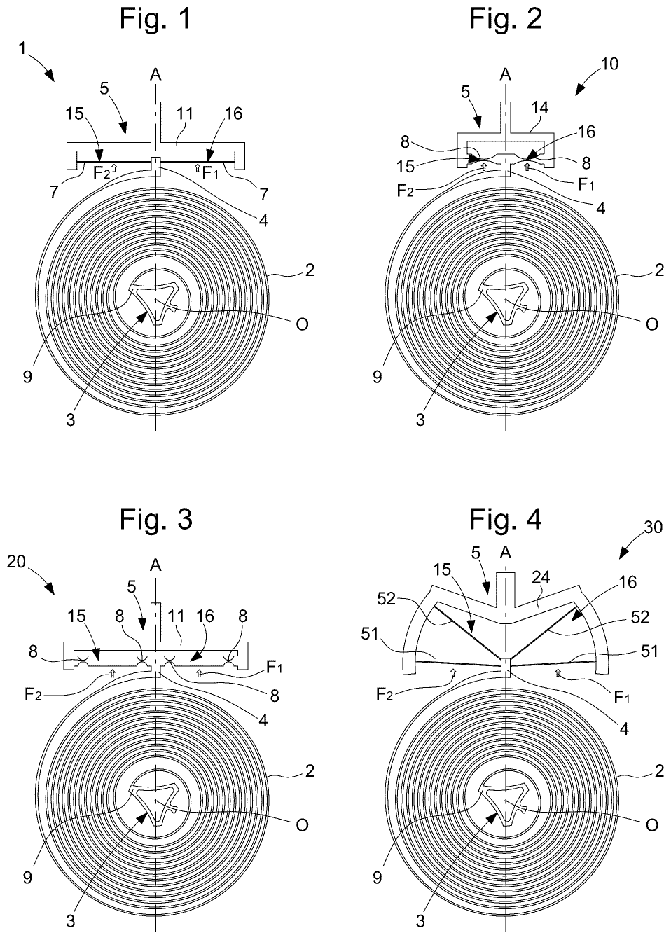

FIGS. 1 to 13 each show a schematic representation of a different embodiment of a balance spring 1, 10, 20, 30, 40, 50, 60, 70, 80, 90, 100, 110, in particular for a watch resonator mechanism. In this case, the balance spring extends substantially in one plane. The balance spring 1, 10, 20, 30, 40, 50, 60, 70, 80, 90, 100, 110 comprises a flexible strip 2 wound on itself in a plurality of coils, the strip 2 having a predefined stiffness. The balance spring has means for adjusting its stiffness. For example, the adjustment means can be actuated when the balance spring is mounted on a plate of a watch movement.

The adjustment means include a flexible element 5 arranged in series with the strip 2, the flexible element 5 connecting one end 4, 9 of said strip 2 to a fixed mount 11, 14, 17, 24, 29, 38, 44 that is integral to one of the ends 4, 9 of the strip 2. The flexible element 5 adds additional stiffness to that of the strip 2. The flexible element 5 preferably has greater stiffness than the strip 2. The flexible element 5 is arranged in a continuation of the strip 2, in its extension. The adjustment means 5 and the strip 2 are preferably in one piece, or even made of the same material.

The balance spring 1, 10, 20, 30, 40, 50, 60, 70, 80, 90, 100, 110, 120 also includes pre-stressing means 6 for applying a variable force or torque to the flexible element 5. In this way, the stiffness of the balance spring 1, 10, 20, 30, 40, 50, 60, 70, 80, 90, 100, 110 can be adjusted, in particular to improve the rate precision of the movement.

The end of the strip 2 preferably remains substantially immobile, whatever the adjustment of the pre-stressing means. The force or torque applied to the flexible element 5 does not alter the position of the end 4 of the strip 2 to which the flexible element is connected. Only the flexible element 5 is acted on to alter its stiffness without acting directly on the strip 2. This provides even greater precision, as only one element is used to adjust the stiffness. During oscillation, the end 4 of the strip 2 can be movable.

In addition, the torque or force is continuously adjustable by the pre-stressing means 6. In other words, the torque or force is not restricted to one-time values. The stiffness of the flexible element 5 can therefore be adjusted with great precision.

Pre-stressing means 6 preferably allow the flexible element 5 to move in translation or rotation in the plane of the balance spring. In this way, the stiffness of the flexible element 5 can be varied.

The embodiments described below comprise a flexible element 5 integral to the outer end 4 of the strip 2. The inner end 9 of the strip 2 is connected to a mount 3 of an oscillating mass of the resonator. In alternative embodiments, not shown in the drawings, the flexible element is connected to the inner end of the strip, so as to be in series between the strip and the oscillating mass mount.

In the embodiments of balance springs 1, 10, 20, 30, 40, 50, 60, 70, 80, 90, 100, 110, 120 described in FIGS. 1 to 13, the flexible element 5 comprises two flexible parts 15, 16 each connecting the strip 2 to the fixed mount 11, 14, 17, 24, 29, 38, 44.

According to the invention, the two flexible parts 15, 16 are arranged relative to each other with axial symmetry along an axis A of the balance spring. In other words, the two flexible parts 15, 16 are positioned so as to be symmetrical relative to said axis A.

The axis A preferably passes substantially through the centre 0 of the balance spring 1, 10, 20, 30, 40, 50, 60, 70, 80, 90, 100, 110, 120, and furthermore, the axis A preferably passes through the outer end 4 of the strip 2.

Thus, the two flexible parts 15, 16 are arranged on the periphery of the balance spring, such that the two flexible parts 15, 16 are arranged at the same distance from the centre 0 of the balance spring 1, 10, 20, 30, 40, 50, 60, 70, 80, 90, 100, 110, 120.

The two flexible parts 15, 16 are preferably arranged relative to each other with a “mirror” effect relative to the axis A. To this end, the two flexible parts 15, 16 are preferably substantially identical.

The pre-stressing means 6 preferably apply a substantially identical force or torque to each flexible part 15, 16. The directions of the forces are preferably substantially parallel.

In one variant, the pre-stressing means 6 apply forces or torques independent of each other to each flexible part 15, 16.

Alternatively, the pre-stressing means 6 apply a single force or torque, which is redistributed over the two flexible parts 15, 16, preferably in a substantially equal manner.

In the balance spring 1 in the first embodiment, the adjustment means comprise a single flexible blade 7 as the flexible part 15, 16. The flexible element 5 also includes a fork-shaped fixed mount 14 with two prongs 17, 18. Each flexible blade 7 connects the end 4 of the strip 2 to a different prong 17, 18 of the fixed mount 14. The flexible blades 7 are arranged on the same axis in the rest position of the balance spring 1.

In the example appearing in FIG. 2, each flexible part 15, 16 of the flexible element 5 of the balance spring 1 comprises a neck 8 thinned in terms of the material thickness, with the neck 8 being flexible. The flexible element 5 also includes a fork-shaped fixed mount 14 with two prongs 17, 18 as in the first embodiment. Each neck 8 connects the end 4 of the strip 5 to a prong 17, 18, with the necks 8 being arranged in the same direction.

The third embodiment of the balance spring 10 appearing in FIG. 3 has flexible parts comprising two flexible necks connected by a rigid section.

In the fourth embodiment of the balance spring 20 appearing in FIG. 4, each flexible part 15, 16 of the flexible element 5 of the balance spring 20 comprises a pivot with offset flexible blades. In this case, the pivot comprises two offset flexible blades 51, 52 joined, on the one hand, to the end 4 of the strip 2 and, on the other hand, to the prongs of the fixed mount 24, by pulling away from each other. A first flexible blade of each pivot is arranged in a tangential direction to the end 4, while a second flexible blade is oblique by moving away from the end 4.

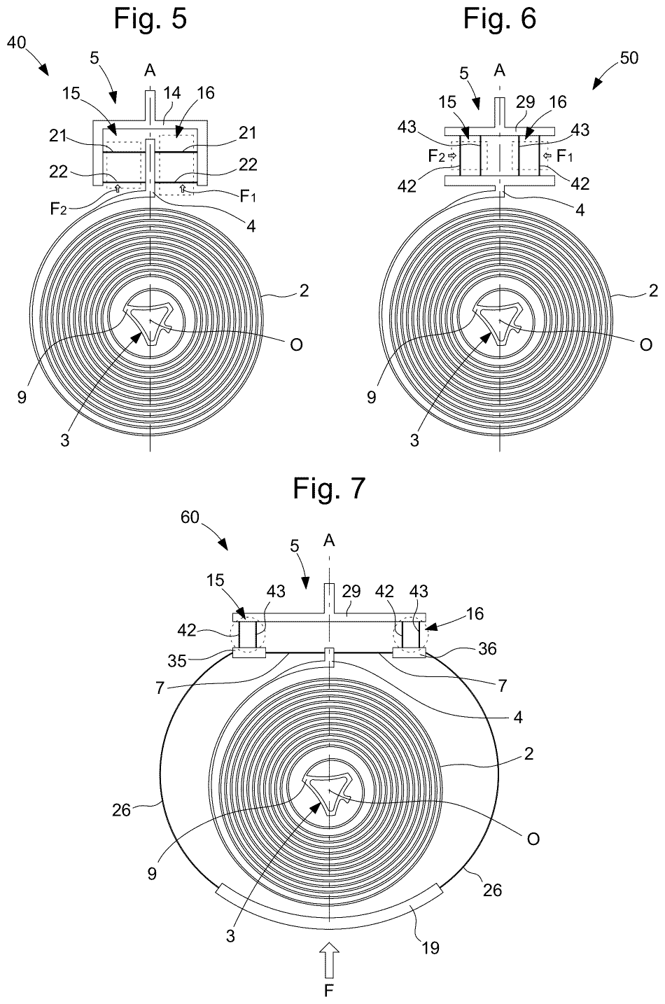

FIGS. 5, 6 and 7 show a balance spring 30, the flexible parts of the flexible element 5 of which include a translation table. The translation table comprises two flexible blades. The flexible blades 21, 22 are substantially parallel and are arranged on different lines. The flexible blades 21, 22 of a translation table are preferably joined to the same face 25 of the fixed mount. The rigid part 23 has an elongated rectangular form, to which the outer end 4 of the strip 2 is joined, in its extension, on one side of the rigid part 23. The secondary flexible blades 21, 22 are substantially perpendicular to the rigid part 23 and to the outer end 4. In the drawing, the variable force or torque is applied to the rigid part 23, preferably parallel to the blades 21, 22.

In FIG. 5, the fixed mount 14 takes the form of a two-pronged fork, with the blades of a translation table connecting the end 4 to a prong of the fork. The blades are arranged in a tangential direction to the end 4 of the strip 2.

In the balance spring 50 in FIG. 6, the flexible blades of the translation tables of each flexible part 16, 17 are substantially parallel to the axis of symmetry A of the flexible element 5. Each fixed mount 29 takes the form of an inverted T, with the flexible blades connecting the top of the T to the end 4 of the strip 2. The end 4 has a form elongated tangentially to the strip 2, and to which the flexible blades of the translation tables are joined.

To alter the overall stiffness of the balance springs 1, 10, 20, 30, 40, 50 in the preceding embodiments, the pre-stressing means 6 apply a variable force or torque to each flexible part 16, 17 of the flexible element 5. For example, forces F₁, F₂ are represented by arrows pointing towards the flexible parts 16, 17.

This alters the stiffness of the flexible parts 15, 16 of the flexible element 5 and therefore of the assembly comprising the strip 2 and the flexible element 5.

The pre-stressing means 6 include, for example, a screw (not shown in the drawings) in contact with each flexible part 16, 17 for applying said forces F₁, F₂.

Alternatively, the pre-stressing means 6 comprise one or more actuators in contact with the flexible parts 16, 17 of the flexible element 5.

The variable force or torque applied to each flexible part 15, 16 is preferably identical. However, in these embodiments, the variable force or torque applied to each flexible part 15, 16 may differ.

In the balance spring 60 in FIG. 7, the flexible blades of the translation tables for each flexible part 16, 17 are substantially parallel to the axis of symmetry A of the flexible element 5. Each fixed mount 29 takes the form of an inverted T, with the flexible blades connecting the top of the T to the end 4 of the strip 2. The end 4 has a form elongated tangentially to the strip 2, and to which the flexible blades of the translation tables are joined.

The flexible parts 16, 17 of the balance spring 60 in FIG. 7 comprise two movable bodies 35, 36 each connected to the end 4 of the strip 2 by a secondary flexible blade 7 substantially tangential to the strip 2. The flexible blades 42, 43 of a translation table connect a movable body 35, 36 to the fixed mount 29 in the form of an inverted T and are substantially perpendicular to the secondary blades 7.

The pre-stressing means 6 also comprise a third movable body 19 in the form of an arc of a circle, connected to the two movable bodies 35, 36 of the flexible element 5 by two flexible levers 26, 27. Each flexible lever 26, 27 partially surrounds the wound strip 2. The third body 19 is arranged on the other side of the balance spring 60 to the fixed mount 38.

To alter the overall stiffness of the balance spring 60, the pre-stressing means 6 apply a variable force or torque to the third movable body 19 of the pre-stressing means 6. For example, a force F is represented by an arrow pointing towards the third body 19. The force F is preferably parallel to the axis A.

In this case, a substantially identical force is transmitted to the two flexible parts 16, 17 of the flexible element 5, from a single force F applied to the third body 19, via the two levers 26, 27.

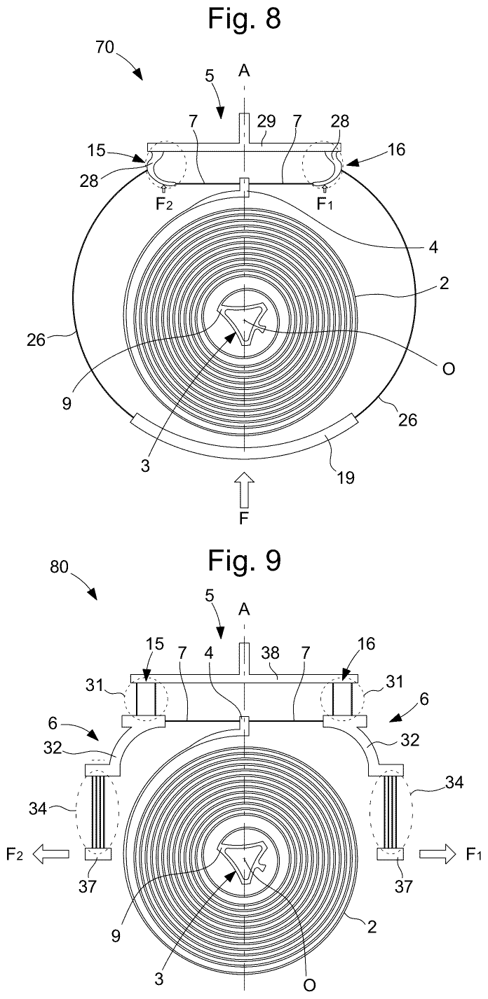

In FIG. 8, the flexible parts 15, 16 of the flexible element 5 of the balance spring 70 have a rounded flexible hook 28 in place of the prongs of the fixed mount 44. The tips of the flexible hooks 28 are directed towards the end 4 of the strip 2 and are connected to the end 4 of the strip 2 by a single flexible blade 7.

The flexible hooks 28 are also connected by two flexible levers 26, 27 to a body in the form of an arc of a circle, arranged on the other side of the balance spring 70 to the fixed mount 29, as in the previous embodiment.

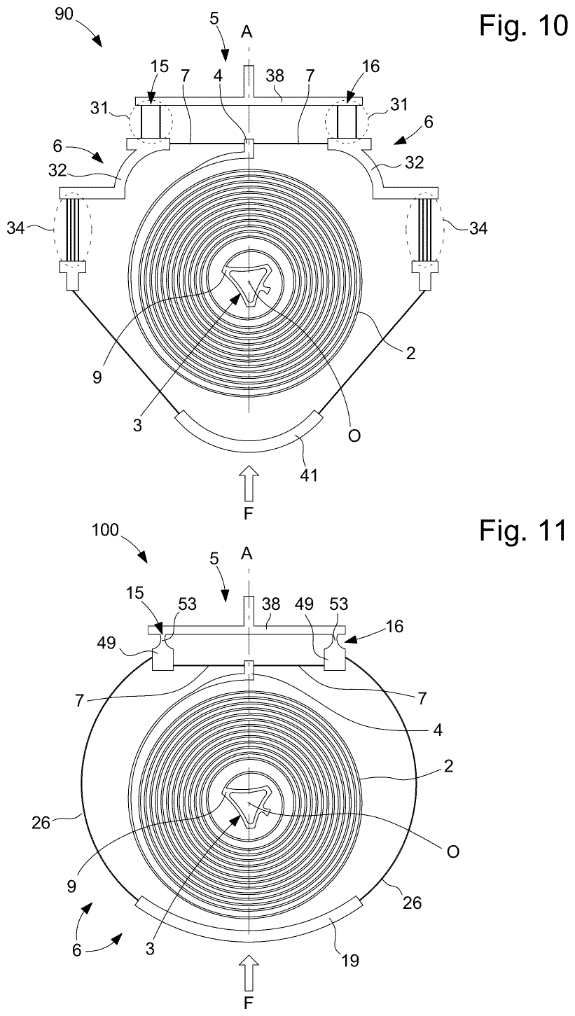

The embodiments of the balance spring 90 in FIGS. 9 and 10 comprise flexible parts 15, 16 each equipped with a translation table 31, a single flexible blade 7, and a first movable body 32 as in the embodiment in FIG. 7.

The first movable bodies 32 are curved, and the blades 33 of the translation table 31 are arranged at one end of the first movable body 32.

The pre-stressing means 6 also comprise a spring 34 connecting the first movable body 32 to a second movable body 37. In this case, the spring 34 is formed by a plurality of substantially parallel tertiary blades, for example three tertiary blades, connected to the other end of the first movable body 32.

The second moving bodies 37 are arranged on either side of the balance spring 80. The second moving bodies 37 receive a variable force or torque, which they transmit to the first moving bodies 32 via the springs 34.

In the embodiment of the balance spring 90 in FIG. 10, the pre-stressing means 6 also include two levers 39 each connecting the second movable body 37 to a third movable body 41 in the form of an arc of a circle arranged on the other side of the balance spring 90 to the fixed mount 38.

The variable force or torque is applied to the third movable body 41, for example by means of an actuator or a screw in contact with the third movable body 41. The variable force or torque is at least partly transmitted to the flexible parts 15, 16 of the flexible element 5, via the springs 34.

The eleventh embodiment of the balance spring 100 in FIG. 11 shows flexible parts 15, 16 comprising two first movable bodies 49 each connected by a neck 53 to the fixed mount 38 in the form of an inverted T. Each first movable body 49 is also connected to the outer end 4 of the strip 2 by a single flexible blade 7.

The pre-stressing means 6 also include two levers 26 each connecting the second movable body 37 to a third movable body 19 in the form of an arc of a circle arranged on the other side of the balance spring 100 to the fixed mount 38.

The variable force or torque is applied to the third movable body 19, for example by means of an actuator or a screw in contact with the third movable body 19. The variable force or torque is at least partly transmitted to the necks 53 of the flexible parts 15, 16 of the flexible element 5, via the levers 26.

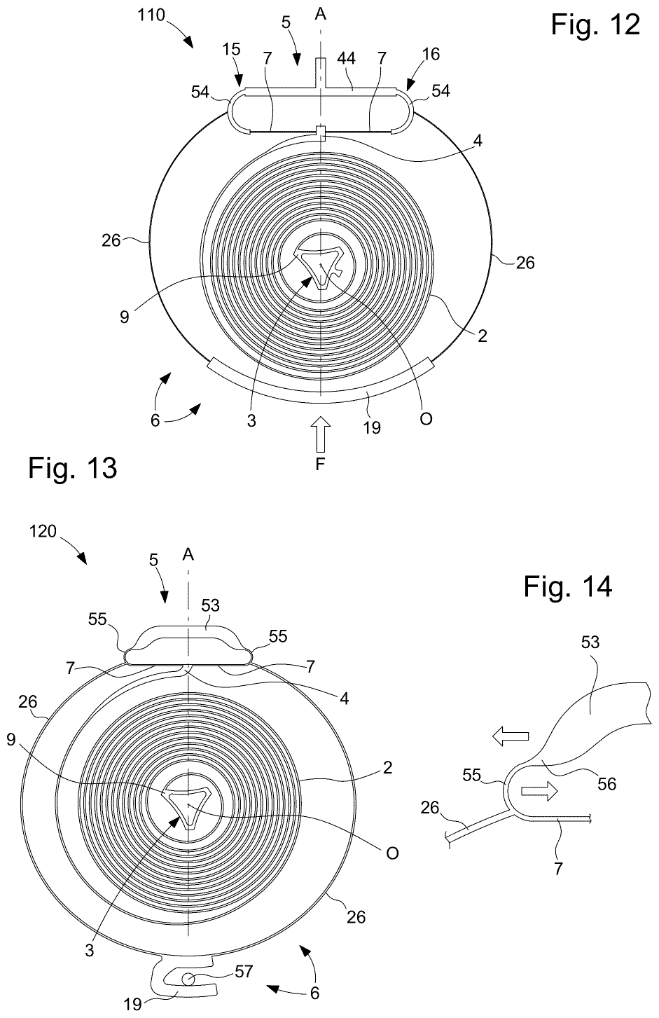

In the twelfth embodiment appearing in FIG. 12, the flexible parts 15, 16 each include a curved flexible rod 54, preferably forming a semicircle, and extending from the end of the fixed mount 44 in the form of an inverted T. Each curved flexible rod 54 is also connected to the outer end 4 of the strip 2 by a single flexible blade 7.

The pre-stressing means 6 also include two levers 26 each connecting the curved flexible rod 54 to a movable body 19 in the form of an arc of a circle arranged on the other side of the balance spring 110 to the fixed mount 44.

The variable force or torque is applied to the third movable body 19, for example by means of an actuator or a screw in contact with the third movable body 19. The variable force or torque is at least partly transmitted to each curved flexible rod 54 of the flexible parts 15, 16 of the flexible element 5, via the levers 26.

The thirteenth embodiment appearing in FIG. 13 is a variant of the embodiment appearing in FIG. 12. The curved rods are replaced by curved flexible blades 55. The fixed mount 53 takes the form of a trapezium open on the long side towards the outer end 4 of the strip 2. The movable body 19 is U-shaped, enabling it to engage with an actuator 57 equipped with a hook or a finger inserted into the U, as it is arranged tangentially to the lever 26.

FIG. 14 is an enlarged view of the curved blade 55 of the balance spring 120 in FIG. 13. The curved blade 55 forms a semi-circular curve, which is extended by the single flexible blade 7 at one end and by the fixed mount 53 at the other. The end 56 of the mount itself forms a curve with a counter-curvature opposite that of the curved blade 55. The end 56 of the mount 53 is semi-rigid so that it can be partially deformed.

This arrangement of curvature and counter-curvature makes it possible to avoid altering the isochronism of the adjusting member when the rate is altered using the adjustment means. In effect, the force exerted on the top of the curved blade 55 is compensated by the reaction force of the counter-curvature of the end 56, as illustrated by the arrows in FIG. 14. Thus, only the single flexible blade 7 is subjected to the force or torque applied by the pre-stressing means 6.

The flexible blades described in the various embodiments of the balance spring may be continuous flexible blades, as is generally the case in the drawings, or blades with rigid sections and flexible necks connecting the sections.

The invention also relates to a rotary resonator mechanism, in particular for a watch movement. The resonator mechanism includes an oscillating weight, not shown in the drawings, and a balance spring as described above. The oscillating weight is, for example, an annular sprung balance. The oscillating weight is joined to the balance spring such that it is integral with the mount.

1. A balance spring for a watch resonator mechanism, the balance spring comprising a flexible strip wound on itself in a plurality of coils, the strip having a predefined stiffness, the balance spring including means for adjusting its stiffness, the adjustment means comprising a flexible element arranged in series with the strip, the flexible element connecting one end of said strip to a fixed mount so as to add additional stiffness to the continuation of the strip, the flexible element having a stiffness greater than that of the strip, wherein the flexible element includes two flexible parts each connecting the strip to the fixed mount, the two flexible parts being arranged relative to each other with axial symmetry along an axis, the axis passing substantially through the centre of the balance spring.

2. The balance spring according to claim 1, wherein the two flexible parts are substantially identical.

3. The balance spring according to claim 1, wherein the flexible element is arranged at an outer end of the strip.

4. The balance spring according to claim 1, wherein each flexible part comprises one or two flexible necks.

5. The balance spring according to claim 1, wherein each flexible part includes a translation table equipped with two substantially parallel flexible blade and a movable rigid part to which the strip is connected.

6. The balance spring according to claim 1, wherein each flexible part comprises a flexible guide equipped with two offset blades.

7. The balance spring according to claim 1, wherein each flexible part comprises a flexible arm to which the strip is connected.

8. The balance spring according to claim 1, wherein each flexible part comprises a flexible blade.

9. The balance spring according to claim 1, wherein each flexible part comprises a flexible hook.

10. The balance spring according to claim 1, wherein the adjustment means include pre-stressing means for applying a variable force or torque to the flexible element, so as to vary the stiffness of the flexible element only.

11. The balance spring according to claim 10, wherein the pre-stressing means are configured to apply a variable force or torque to each part of the flexible element.

12. The balance spring according to claim 1, wherein the torque or force is continuously adjustable by the pre-stressing means.

13. The balance spring according to claim 1, wherein the pre-stressing means are configured to apply an identical variable force or torque to each part of the flexible element.

14. The balance spring according to claim 1, wherein the pre-stressing means comprise a screw configured to rest against the flexible element.

15. The balance spring according to claim 1, wherein the pre-stressing means comprise two flexible levers each connected to a flexible part.

16. The balance spring according to claim 15, wherein the pre-stressing means comprise two springs, each spring being connected to a flexible part.

17. The balance spring according to claim 1, wherein the pre-stressing means comprise a secondary flexible blade connected to each flexible part.

18. The balance spring according to claim 15, wherein the two levers are connected to each other by a movable body.

19. A rotary resonator mechanism for a watch movement, including an oscillating weight, and the balance spring according to claim 1.
